(19) United States
(12) Patent Application Publication
(10) Pub. No.: US 2005/0161427 A1
(43) Pub. Date: Jul. 28, 2005

(54) Method of working a workpiece containing magnetic material and method of manufacturing a magnetic recording medium

(75) Inventors: Shuichi Okawa, Tokyo (JP); Kazuhiro Hattori, Tokyo (JP); Mitsuru Takai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/038,256

(22) Filed: Jan. 21, 2005

(30) Foreign Application Priority Data
Jan. 22, 2004 (JP) 2004-014055

(51) Int. Cl. H01B 13/00

(52) U.S. Cl. 216/20

(57) ABSTRACT

A method of working a workpiece containing magnetic material and a method of manufacturing a magnetic recording medium capable of effectively manufacturing a magnetic recording medium and a magnetic recording and reproducing device, in that a workpiece containing magnetic material is worked by means of dry etching and washed in an alkaline solution, for example, the workpiece is subjected to scrubbing or ultrasonic washing.

### BACKGROUND OF THE INVENTION

The present invention is related to a method of working a workpiece containing magnetic material and a method of manufacturing a magnetic recording medium used for manufacturing a magnetic recording medium such as a magnetic recording disk and also used for manufacturing a magnetic recording and reproducing device such as a magnetic head.

In the field of manufacturing a magnetic recording medium and a magnetic recording and reproducing device, the storage capacity has been increased and further the magnetic recording medium and the magnetic recording and reproducing device have been made compact recently. According to that, fine working technique of the magnetic material becomes more important.

For example, in the case of a magnetic recording medium such as a hard disk, the surface recording density has been remarkably enhanced when magnetic particles composing a recording layer are made fine and material of the magnetic particles is changed. However, an enhancement of the surface recording density by the above conventional improving method has already reached its limit. Therefore, in order to realize a further enhancement of the surface recording density, the following magnetic recording media have been proposed; for example, refer to Japanese Patent Publication 9-97419. They are a discrete track type magnetic recording medium, in which a continuous recording layer (magnetic material) is divided into a large number of division recording elements, and a patterned medium type magnetic recording medium.

In order to utilize a magnetic recording medium having a high surface recording density, it is necessary to work the magnetic head to be fine.

Concerning the technique of micro-working the magnetic material, it is possible to use the method of ion beam etching which is frequently used in the field of manufacturing a semiconductor device. It is also possible to use the method of dry etching such as reactive ion etching in which halogen group gas or oxygen group gas is used as reaction gas. In this connection, as the method of dry etching suitably used for magnetic material, reactive ion etching, in which CO (carbon monoxide) gas is used as reactive gas, is well known; for example, refer to Japanese Patent Publication 2000-322710. In the case of using this reactive ion etching, in order to work a mask layer, the method of reactive ion etching, in which halogen group gas or oxygen group gas is used as reactive gas, can be used.

On the other hand, in the process of manufacturing a conventional magnetic recording medium having a continuous recording layer and also in the process of manufacturing a master disk for magnetic transfer which is used for conducting magnetic transfer on a magnetic recording medium, a washing step, in which purified water or IPA (isopropyl alcohol) is used, is adopted until now. It has been confirmed that this washing step is sufficiently effective in the case where impure particles attached in the atmosphere or in the process of film forming are removed; for example, refer to Japanese Patent Publication 2003-51109.

However, in the case where the above working step is applied to a surface of the magnetic recording medium, since the step of dry etching is included in the working of magnetic material, a large number of fragments (particles) generated in the process of dry etching remain on the surface of the magnetic recording medium. Therefore, according to the conventional washing method in which purified water or IPA is used, it is difficult to realize a magnetic recording medium surface which is sufficiently clean so that it can be used for the magnetic recording medium.

Further, in some cases, a large number of impure particles, which are generated in the steps of resist coating and mask layer processing before conducting working on the magnetic material by means of dry etching, are existing on or adhering to the surface of the magnetic material. Due to these impure particles, corrosion may be caused. In the case of using the means of dry etching in which reactive gas is used for working the magnetic material or the mask layer, since gas having a high reactivity with the magnetic material or gas (for example, halogen group gas or oxygen group gas) having a property of corroding or oxidizing the magnetic material is used, when the components of these gases are not completely removed, corrosion and oxidization are caused by the gas components.

A change in the material such as corrosion or oxidization described above provides a fatal fault to the magnetic recording and reproducing device such as a discrete track type or a patterned media type magnetic recording medium or magnetic head in which the characteristic of the magnetic material, which is a workpiece, is utilized.

### SUMMARY OF THE INVENTION

The present invention has been accomplished to solve the above problems. It is a task of the present invention to provide a method of working a workpiece containing magnetic material and a method of manufacturing a magnetic recording medium capable of effectively manufacturing a magnetic recording medium and a magnetic recording and reproducing device, the magnetic characteristic of which is high, by working a workpiece containing magnetic material by means of dry etching and by positively removing particles and impurities remaining on a surface of the magnetic material.

According to the present invention, when a workpiece containing magnetic material is washed with an alkaline solution, particles and impurities remaining on a surface of the magnetic material are effectively and surely removed.

The reason why particles and impurities remaining on a surface of the magnetic material can be effectively and surely removed by washing a workpiece containing magnetic material with an alkaline solution is briefly described as follows. Most of the particles remaining on the surface of the magnetic material are electrically charged negative. When the workpiece is washed with the alkaline solution, a surface potential (zeta |ξ| potential) on the surface of the magnetic material can be made negative. As a result, particles, which are electrically charged negative, remaining on the surface of the magnetic material repulse each other and easily separate from the surface of the magnetic material. Therefore, the particles can be effectively removed.

Since the alkaline solution has a reducing property, it is possible to effectively remove oxidizing gas remaining on the magnetic material surface, which causes corrosion and oxidization, such as halogen group gas of fluorine gas and chlorine gas and oxygen group gas of oxygen gas and ozone gas. Further, it is possible to prevent an oxidizing reaction on the surface of the magnetic material caused by those gases.

The above problems have been solved by the techniques of the present invention.

According to first aspect of the invention, a method of working a workpiece containing magnetic material comprises: a working step in which a workpiece containing magnetic material is worked by means of dry etching; and a washing step in which the workpiece is washed by an alkaline solution. Therefore, it is possible to effectively and surely remove particles and impurities remaining on the magnetic material surface generated in the process of dry etching and it is also possible to effectively and surely remove oxidizing gas, which causes corrosion and oxidization, remaining on the magnetic material surface such as halogen group gas and oxygen group gas. It is possible to positively prevent an oxidizing reaction caused on the magnetic material surface by those gases.

According to second aspect of the invention, the washing step includes a scrubbing step in which a surface of the workpiece is scrubbed by a piece of sponge in the alkaline solution. Therefore, particles and impurities remaining on the magnetic material surface can be more positively removed.

According to third aspect of the invention, the washing step includes an ultrasonic washing step in which the workpiece is washed by ultrasonic washing in the alkaline solution. Therefore, particles and impurities remaining on the magnetic material surface can be more positively removed.

According to fourth aspect of the invention, an ultrasonic frequency of the ultrasonic washing is increased high. Therefore, particles and impurities remaining on the magnetic material surface can be more positively removed.

According to fifth aspect of the invention, the dry etching is conducted in a reactive gas. Therefore, the workpiece containing magnetic material can be effectively worked.

According to sixth aspect of the invention, the reactive gas includes at least one of halogen group gas and oxygen group gas. Therefore, the workpiece containing magnetic material can be more effectively worked.

According to seventh aspect of the invention, the alkaline solution includes ammonia. Therefore, oxidizing gas such as halogen group gas remaining on the magnetic material surface, which causes corrosion and oxidization, can be more effectively and positively removed.

According to eighth aspect of the invention, a method of manufacturing a magnetic recording medium containing magnetic material is provided by the method of working a workpiece containing magnetic material as described above. Therefore, particles and impurities, which are generated in the process of dry etching, remaining on the magnetic material surface can be effectively and positively removed. Accordingly, it is possible to effectively and positively manufacture a magnetic recording medium, the magnetic characteristic of which is excellent.

### BRIEF DESCRIPTION OF THE DRAWINGS

FIG. 1 is a sectional side view showing a model of the structure of the starting body of the sample relating to the embodiment of the present invention.

FIG. 2 is a sectional side view showing a model of the structure of the sample obtained when the starting body is worked.

FIG. 3 is a flow chart showing a working step of the sample.

FIG. 4 is a sectional side view showing a shape of the sample, on the resist layer of which a pattern is transferred by the imprint method.

FIG. 5 is a sectional side view showing a shape of the sample, the resist layer of which is divided by a pattern.

FIG. 6 is a sectional side view showing a model of the shape of the sample, the second mask layer on the groove bottom face of which is removed.

FIG. 7 is a sectional side view showing a model of the shape of the sample, the first mask layer on the groove bottom face of which is removed.

FIG. 8 is a sectional side view showing a model of the shape of the sample, the magnetic thin layer of which is divided.

FIG. 9 is a flow chart showing a washing step of the sample.

### DETAILED DESCRIPTION OF THE PREFERRED EMBODIMENTS

The most preferred embodiment of the present invention will be explained in detail, referring to the drawings.

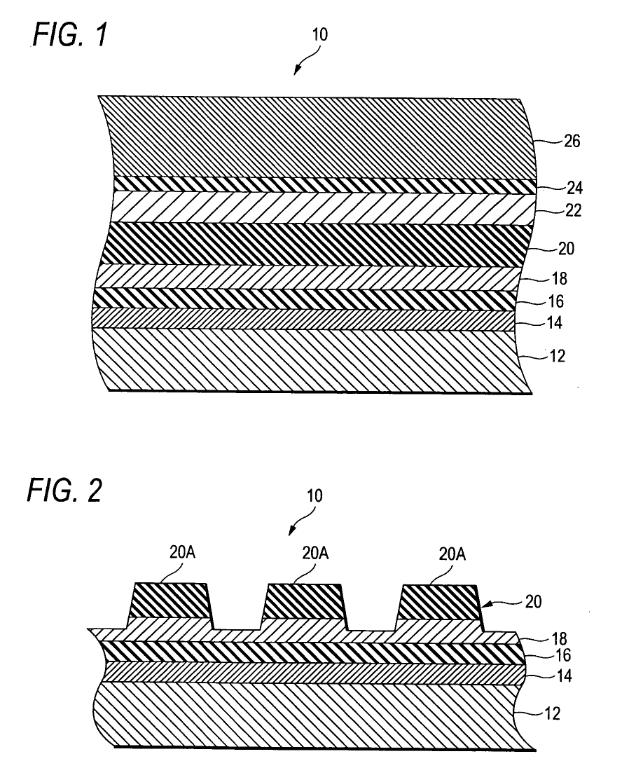

In this embodiment, when dry etching is conducted on the sample (the workpiece) 10 containing the magnetic thin layer (magnetic material) 20 shown in FIG. 1, the magnetic thin layer 20 is worked into a shape of a predetermined line and space pattern shown in FIG. 2. This embodiment is characteristic in the working step and the washing step conducted after the working step. The constitution of the apparatus to be used is the same as that of the conventional case. Therefore, the explanations are appropriately omitted here.

A starting body from which the working of the sample 10 is started includes a glass substrate 12, an under layer 14, a soft magnetic layer 16, an orientation layer 18, a hard magnetic layer 20, a first mask layer 22, a second mask layer 24 and a resist layer 26, wherein these layers are formed in this order.

The under layer 14 is 30 to 200 nm thick and made of Cr (chromium) or Cr alloy. The soft magnetic layer 16 is 50 to 300 nm thick and made of Fe (iron) alloy or Co (cobalt) alloy. The orientation layer 18 is 3 to 30 nm thick and made of CoO (cobalt oxide), MgO (magnesium oxide) and NiO (nickel oxide). The magnetic thin layer 20 is 5 to 30 nm thick and made of CoCr (cobalt-chromium) alloy. The first master layer 22 is 3 to 20 nm thick and made of TaSi alloy (The ratio of composition is Ta: 80%, Si: 20% at the atomic ratio.) The second mask layer 24 is 3 to 15 nm thick and made of Ni (nickel). The resist layer 26 is 30 to 300 nm thick and made of a negative type resist (NEB22A manufactured by Sumitomo Co., Ltd.).

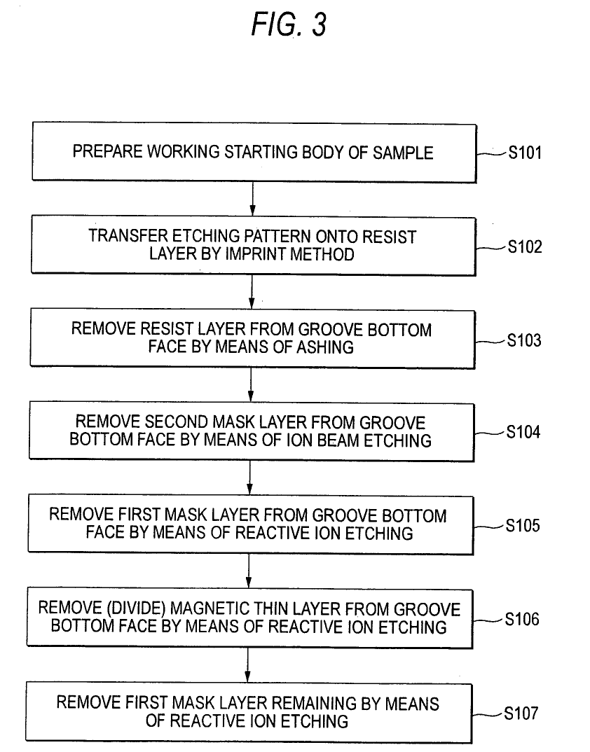

Next, referring to the flow chart shown in FIG. 3, the working step in which the sample 10 is worked will be explained below.

First of all, the starting body of the sample 10 shown in FIG. 1 is prepared (S101). The starting body of the sample 10 is obtained when the under layer 14, the soft magnetic layer 16, the orientation layer 18, the magnetic thin layer 20, the first mask layer 22 and the second mask layer 24 are formed on the glass substrate 12 by the method of spattering in this order and further the resist layer 26 is coated by the method of spin coating.

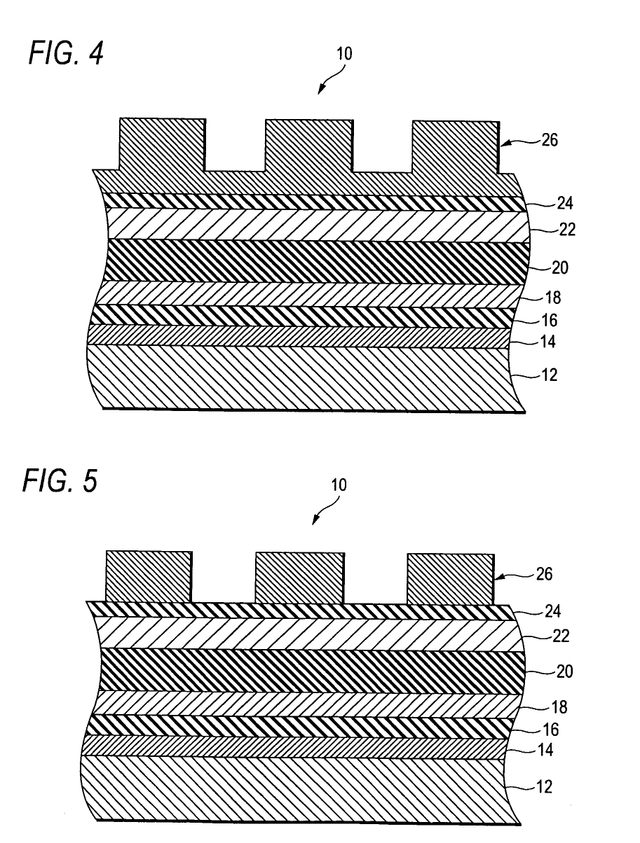

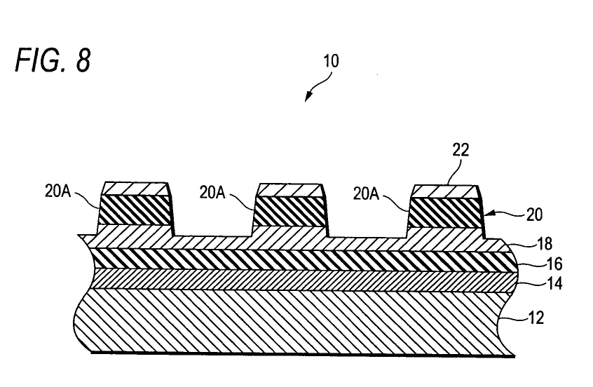

A predetermined sub-pattern (not shown) including grooves and contact holes corresponding to the division pattern of the division recording elements 20A shown in FIG. 8 is transferred onto the resist layer 26 of the workpiece 10 by the imprint method as shown in FIG. 4 (S102). When the imprint method is used as described above, the grooves corresponding to the division pattern can be effectively transferred onto the workpiece 10 to be worked.

Next, by the method of ashing, which is an example of dry etching conducted in a reactive gas, in which plasma of oxygen gas, which is an example of the oxygen group gas, is used, the resist layer 26 is removed from the bottom face of the recess portion of the protruding and recessing pattern as shown in FIG. 5 (S103). In this connection, in this case, the resist layer 26 in the region except for the recess portion is somewhat removed, however, the resist layer 26 corresponding to the step with the bottom face of the recess portion remains. In this connection, of course, it is possible to form grooves corresponding to the division pattern on the workpiece 10 by means of lithography.

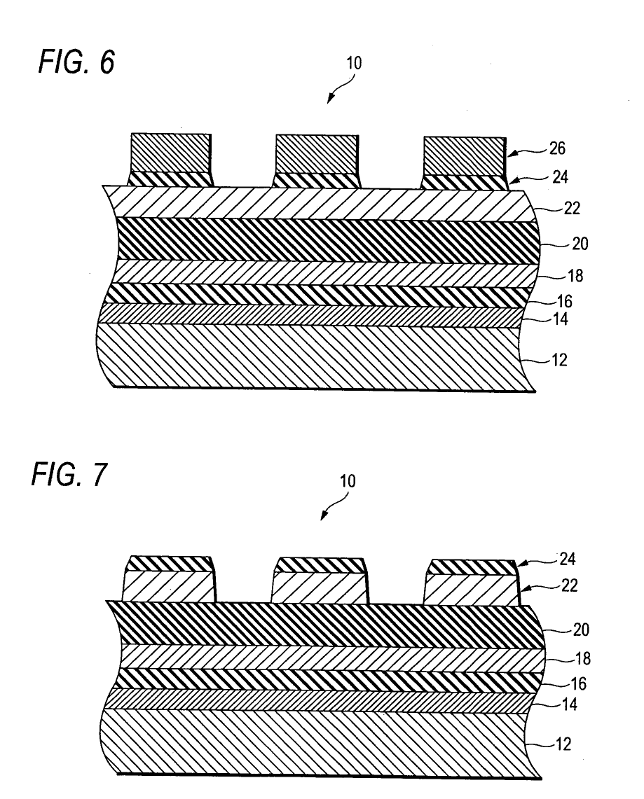

Next, as shown in FIG. 6, the second mask layer 24 is removed from the groove bottom face by means of ion etching in which Ar (argon) gas is used (S104). In this connection, the resist layer 26 except for the groove is somewhat removed at this time.

Next, by means of reactive ion etching in which SF₆ gas, which is an example of the halogen group gas, is used as a reactive gas, the first mask layer 22 is removed from the bottom face of the groove as shown in FIG. 7 (S105).

Due to the foregoing, the magnetic thin layer 20 is exposed to the bottom face of the groove. In this connection, in this case, the resist layer 26 in the region except for the groove is completely removed. The second mask layer 24 in the region except for the groove is partially removed and some portion of the second mask layer 24 remains.

Next, by means of reactive ion etching in which carbonyl group gas (for example, mixed gas of CO gas with NH₃ gas) is used as a reactive gas, as shown in FIG. 8, the magnetic thin layer 20 is removed from the bottom face of the groove (S106). Due to the foregoing, the magnetic thin layer 20 is divided into a large number of recording elements 20A.

In this connection, by this reactive ion etching, the second mask layer 24 in the region except for the groove is completely removed. Further, the first mask layer 22 in the region except for the groove is partially removed, however, a predetermined quantity of the first mask layer 22 remains on an upper face of the recording element 20A.

Next, by means of reactive ion etching in which SF₆ gas (an example of the halogen group gas) is used, as shown in FIG. 8, the first mask layer 22 remaining on an upper face of the recording element 20A is completely removed (S107).

Due to the foregoing, the working of the sample 10 shown in FIG. 2 is completed.

When dry etching is conducted in which oxygen group gas such as oxygen gas and halogen group gas such as SF₆ gas are used as a reactive gas, the sample 10 can be effectively worked.

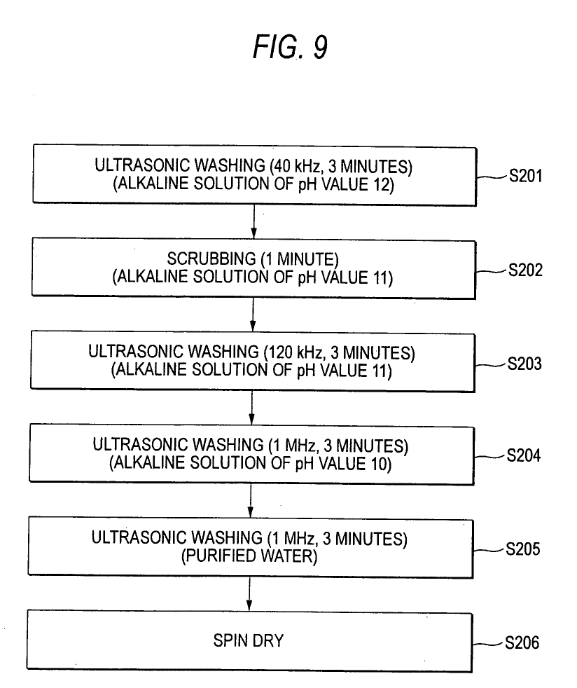

Next, referring to the flow chart shown in FIG. 9, the washing step for washing the sample 10 will be explained below.

First, an example will be described as follows. While the sample 10, which has already been worked, is being dipped in an ammonium solution (an example of the alkaline solution), the pH value of which is approximately 12, ultrasonic waves of about 40 kHz are impressed upon the sample 10 so as to conduct ultrasonic washing for about 3 minutes (S201).

Next, as an example, while the sample 10 is being dipped in an ammonium solution, the pH value of which is approximately 11, the surface of the sample 10 is scrubbed with a piece of PVA (polyvinyl alcohol) sponge for about 1 minute (S202).

Next, as an example, while the sample 10 is being dipped in an ammonium solution, the pH value of which is approximately 11, the sample 10 is impressed with ultrasonic waves of about 120 kHz so as to conduct ultrasonic washing for about 3 minutes (S203).

Next, as an example, while the sample 10 is being dipped in an ammonium solution, the pH value of which is approximately 10, the sample 10 is impressed with ultrasonic waves of about 1 MHz so as to conduct ultrasonic washing for about 3 minutes (S204).

Next, as an example, while the sample 10 is being dipped in purified water, the sample 10 is impressed with ultrasonic waves of about 1 MHz so as to conduct ultrasonic washing for about 3 minutes (S205). After that, the sample 10 is dried by means of spin dry (S206).

Due to the foregoing, washing of the sample shown in FIG. 2 is completed.

After the completion of washing the sample 10, a protective layer of DLC (diamond-like-carbon) is formed on the surface of the magnetic thin layer of the sample 10 by the method of CVD (Chemical Vapor Deposition), and a lubricant layer of PFPE (Per-Fluoro PolyEther) is coated on it by the dipping method. In this way, a magnetic recording medium is completed. Even when washing is conducted as described above after the film of DLC has been formed on the surface of the magnetic thin layer, a predetermined effect, in which particles and impurities remaining on the surface are removed, can be provided.

It is possible to adopt the following constitution. After the recess portion provided between the recording elements 20A has been filled with non-magnetic material such as SiO₂, irregularities on the surface of the magnetic recording medium are made flat by means of dry etching. In this case, when washing is conducted as described above after the surface has been flattened, impure particles generated at the time of flattening the surface can be effectively and positively removed.

When the sample 10 is washed with an alkaline solution, a surface potential (ξ potential) on the surface of the sample 10 (the magnetic material surface) can be made negative. As a result, particles, which are electrically charged negative, remaining on the surface of the magnetic material repulse each other and easily separate from the surface of the magnetic material. Therefore, the particles can be effectively removed. Since the alkaline solution has a reducing property, it is possible to effectively remove oxidizing gas, which causes corrosion and oxidization, such as oxygen gas and SF₆ gas remaining on the surface of the sample 10. Further, it is possible to prevent an oxidizing reaction on the surface of the sample 10 caused by those gases. Therefore, impurities such as particles remaining on the magnetic material surface generated in the process of dry etching and reaction gases can be effectively removed. Accordingly, it is possible to effectively and positively manufacture a magnetic recording medium having an excellent magnetic property.

Further, when washing is conducted in an alkaline solution which is an ammonium solution containing ammonium, oxidizing halogen group gas, which causes corrosion and oxidation, such as SF₆ gas remaining on the surface of the sample 10 can be more effectively and positively removed.

Further, when the surface of the sample 10 is scrubbed in the alkaline solution with a piece of PVA sponge, particles and impurities remaining on the surface of the sample 10 can be more effectively and positively removed.

When ultrasonic washing is conducted on the sample 10 in the alkaline solution, particles and impurities remaining on the surface of the sample 10 can be more effectively and positively removed.

Further, when the ultrasonic frequency used for ultrasonic washing is increased high, particles and impurities remaining on the surface of the sample 10 can be more effectively and positively removed. The reason is described as follows. When the ultrasonic frequency is relatively low, particles sticking onto the magnetic material surface can be highly effectively removed. When the ultrasonic frequency is relatively high, particles, which have been already removed, are prevented from sticking onto the magnetic material again. Accordingly, at the initial stage of washing, washing is conducted at a relatively low ultrasonic frequency. As the washing step proceeds, the ultrasonic frequency is increased high. Due to the foregoing, particles can be effectively and positively removed. In the case of removing the particles by ultrasonic washing, the appropriate ultrasonic frequency is different according to the diameters of particles to be removed. Accordingly, when washing is conducted by the ultrasonic waves of different frequencies, particles of different particle diameters can be effectively and positively removed.

In this connection, in this embodiment, the washing step is divided into a plurality of steps, and washing is conducted by the same ultrasonic frequency in the same step. When the step proceeds, the ultrasonic frequency is increased. However, the present invention is not limited to this specific embodiment. The ultrasonic frequency may be increased high in the same step. In this case, the ultrasonic frequency may be increased stepwise. Alternatively, the ultrasonic frequency may be increased continuously.

The pH value of the alkaline solution is not particularly limited to a specific value. However, in order to remove the impurities, which have been sucked or stuck onto the magnetic material surface, by electrically charging the surface potential (ξ potential) on the magnetic material surface to the negative side, and in order to prevent the particles from attaching to the magnetic material surface again in the process of washing, it is preferable to provide a step in which an alkaline solution, the pH value of which is not less than pH 11, is used as described later. It is more preferable to provide a step in which an alkaline solution, the pH value of which is not less than pH 12, is used. The upper limit of the pH value is not particularly determined with respect to the effect of washing. The higher the pH value, the higher the washing effect. However, when the pH value exceeds pH 14, there is a possibility that the magnetic material is decomposed. Therefore, it is preferable that the pH value is not more than pH 14.

In this embodiment, the washing step is divided into a plurality of steps, and washing is conducted while the pH value of the alkaline solution is being gradually reduced. The reason why washing is conducted while the pH value of the alkaline solution is being gradually reduced is that the removed particles are washed away and the alkaline solution is replaced with purified water. However, the present invention is not limited to the above specific embodiment. The number of steps, the pH value of the alkaline solution, the dipping time and the ultrasonic frequency may be appropriately adjusted according to the degree of contamination on the magnetic material surface.

The drying method conducted in the step S206 of this embodiment is not limited to the above specific embodiment. For example, IPA steam drying method may be adopted.

In this embodiment, oxygen gas (oxygen group gas) is used as the reactive gas of ashing for the resist layer 26, and SF₆ gas (halogen group gas) is used as the reactive gas of reactive etching for working the first mask layer 22. However, it should be noted that the present invention is not limited to the above specific embodiment. For example, in the case where ashing is conducted on the resist layer 26 by using another oxygen group gas such as ozone instead of oxygen gas and in the case where the first mask layer 22 is worked by using another fluorine group gas such as CF₄ gas instead of SF₆ gas and by using another halogen group reactive gas of chlorine group gas such as Cl₂ gas and BCl₃ gas, when the sample 10 is washed in an alkaline solution, particles remaining on the magnetic material surface and impurities such as a reactive gas can be effectively and positively removed.

In this embodiment, ashing in which oxygen gas (oxygen group gas) is used as a reactive gas is used for removing the resist layer 26 from the bottom face of the recess portion, and reactive etching in which SF₆ gas (halogen group gas) is used as a reactive gas is used for working the first mask layer 22. However, it should be noted that the present invention is not limited to the above specific embodiment. For example, in the case where dry etching, in which oxygen group gas and halogen group gas are used as a reactive gas, is conducted for working the second mask layer 24 and the magnetic thin layer 20, impurities such as particles remaining on the magnetic material surface and a reactive gas can be effectively and positively removed by washing the sample 10 in an alkaline solution.

In this embodiment, the first mask layer 22, the second mask layer 24 and the resist layer 26 are formed on the magnetic thin layer 20, and the magnetic thin layer 20 is divided by means of dry etching of four stages. However, as long as the magnetic thin layer 20 can be worked into a predetermined protruding and recessing pattern, the material of the resist layer, the material of the mask layer, the number of laminated layers, the thickness and the type of dry etching are not particularly limited.

In the present embodiment, the magnetic thin layer 20 is made of CoCr alloy. However, the present invention is not particularly limited to the above specific embodiment. For example, the present invention can be applied to a workpiece made of the other alloys containing iron group elements (Co, Fe, Ni) and the present invention can be also applied to a workpiece made of material containing the other magnetic material. The present invention can be also applied to a workpiece containing the magnetic material of oxide such as ferrite.

In the present embodiment, the under layer 14, the soft magnetic layer 16 and the orientation layer 18 are formed below the magnetic thin layer 20. However, the present invention is not limited to the above specific embodiment. The constitution of the layers below the magnetic thin layer 20 may be appropriately changed according to the type of the magnetic recording medium. For example, one or two of the under layer 14, the soft magnetic layer 16 and the orientation layer 18 may be omitted. Further, the magnetic thin layer 20 may be directly formed in the substrate.

In this embodiment, the sample 10 is to become a discrete track type magnetic recording medium of the perpendicular recording type in which the recording elements 20A are provided in parallel with each other at minute intervals in the radial direction of the track. However, of course, the present invention can be applied to the working of a magnetic disk such as a hard disk, and the present invention can be also applied to the working of various recording media such as an optical magnetic disk, a magnetic tape and a magnetic head having magnetic material.

### EXAMPLES

Referring to the examples of the present invention and the comparative examples, the present invention will be more specifically explained below.

### Example 1

As explained before, ten pieces of samples 10 were manufactured. Specifically, the samples 10 were manufactured as follows. With respect to the working starting body of the sample 10, the recording elements 20A were formed at the intervals of about 200 nm, and the ratio of the recording element width to the groove width was set at 1:1 (shown in FIG. 2). More specifically, dry etching was conducted in S103, S105 and S107 according to the following conditions.

(S103)
Flow rate of oxygen gas: 50 sccm
Pressure in vacuum chamber: 0.3 Pa
Bias power: 100 W

(S105)
Flow rate of SF₆ gas: 20 sccm
Pressure in vacuum chamber: 0.3 Pa
Source power: 1000 W
Bias power: 150 W

(S107)
Flow rate of SF₆ gas: 20 sccm
Pressure in vacuum chamber: 1.0 Pa
Source power: 1000 W
Bias power: 150 W

Ten pieces of samples 10, the working of which was completed, were washed as described in the above example.

Surfaces of the samples 10 obtained as described above were observed through an optical microscope and a scanning type electron microscope. As a result of the observation, the average of the number of particles remaining on the surface was not more than one, that is, a ratio of reduction from the number of particles remaining on the surface before the washing process was conducted was not less than 99.9%. Therefore, it was confirmed that a clean surface was obtained.

Further, the samples 10 were put in a constant temperature oven maintained in a high temperature and humidity environment, in which the temperature was held at 80° C. and the humidity was held at 80%, for about 40 hours.

After that, surfaces of the samples 10 were observed through the optical microscope and the scanning type electron microscope. As a result of the observation, no portion oxidized or corroded was found in any magnetic recording medium.

### Comparative Example 1

With respect to the above example 1, purified water was used for all washing solution, and the other points were made to be the same as those of example 1. Under the above condition, ten pieces of samples 10 were manufactured.

Further, in the same manner as that of example 1, after the completion of washing, surfaces of the samples 10 were observed through the optical microscope and the scanning type electron microscope. As a result of the observation, a ratio of reduction of the number of the particles remaining on the surface from the time before conducting washing was approximately 90%.

Further, in the same manner as that of example 1, the samples 10 were put in the constant temperature oven maintained in a high temperature and humidity environment, in which the temperature was held at 80° C. and the humidity was held at 80%, for about 40 hours. After that, surfaces of the samples 10 were observed through the optical microscope and the scanning type electron microscope. As a result of the observation, all magnetic recording media were corroded, and about 10% of the region, in which the pattern was formed, was corroded.

As described above, when washing was conducted by only purified water, with respect to example 1, it was confirmed that a sufficiently high effect was not provided concerning the removal of the particles remaining on the magnetic material surface and the removal of the reactive gas which could be a cause of oxidation or corrosion.

### Comparative Example 2

With respect to the above example 1, IPA (isopropyl alcohol) was used for the solution used for washing in the steps of S201 and S203, and purified water was used for the solution used for washing in the steps of S202, S204 and S205. Other points were the same as those of example 1. Under the above condition, ten pieces of samples 10 were made.

In the same manner as that of example 1, after the completion of washing, surfaces of the samples 10 were observed through the optical microscope and the scanning type electron microscope. As a result of the observation, a ratio of reduction of the number of the particles remaining on the surface from the time before conducting washing was approximately 70%.

In the same manner as that of example 1, the samples 10 were put in the constant temperature oven maintained in a high temperature and humidity environment, in which the temperature was held at 80° C. and the humidity was held at 80%, for about 40 hours. After that, surfaces of the samples 10 were observed through the optical microscope and the scanning type electron microscope. As a result of the observation, no portion oxidized or corroded was found in any magnetic recording medium.

As described above, in the case of washing in which IPA was used, the reactive gas, which could be a cause of oxidation or corrosion, was effectively removed, however, concerning the removal of the particles remaining on the magnetic material surface with respect to example 1, it was impossible to obtain a sufficiently high effect.

### Example 2

With respect to example 1 described above, the pH value of the ammonium solution used for washing in the step S201 was set at about 11, and the other points were made to be the same as those of example 1. Under the above condition, ten pieces of samples 10 were manufactured.

In the same manner as that of example 1, after the completion of washing, surfaces of the samples 10 were observed through the optical microscope and the scanning type electron microscope. As a result of the observation, a ratio of reduction of the number of the particles remaining on the surface from the time before conducting washing was approximately 99%.

In the same manner as that of example 1, the samples 10 were put in the constant temperature oven maintained in a high temperature and humidity environment, in which the temperature was held at 80° C. and the humidity was held at 80%, for about 40 hours. After that, surfaces of the samples 10 were observed through the optical microscope and the scanning type electron microscope. As a result of the observation, no portion oxidized or corroded was found in any magnetic recording medium.

### Example 3

With respect to Example 1 described above, the pH value of the ammonium solution used for washing in the steps of S201, S202 and S203 was set at about 10, and the other points were made to be the same as those of Example 1. Under the above condition, ten pieces of samples 10 were manufactured.

In the same manner as that of Example 1, after the completion of washing, surfaces of the samples 10 were observed through the optical microscope and the scanning type electron microscope. As a result of the observation, a ratio of reduction of the number of the particles remaining on the surface from the time before conducting washing was approximately 93%.

In the same manner as that of Example 1, the samples 10 were put in the constant temperature oven maintained in a high temperature and humidity environment, in which the temperature was held at 80° C. and the humidity was held at 80%, for about 40 hours. After that, surfaces of the samples 10 were observed through the optical microscope and the scanning type electron microscope. As a result of the observation, no portion oxidized or corroded was found in any magnetic recording medium.

In any of Examples 1 to 3, after the samples were held in the high temperature and humidity environment, no portion oxidized and corroded was observed. However, differences can be found in the ratio of reduction of the particles remaining on the surface from the time before washing was conducted. The ratio of reduction of the particles remaining on the surface from the time before washing was conducted is shown on Table 1 with respect to Examples 1 to 3 and Comparative Example 1. In Example 3, the ratio of reduction was about 93%. On the other hand, in Example 2, the ratio of reduction was about 99%, and in Example 1, the ratio of reduction was about 99.9%, that is, the results of Examples 1 and 2 were excellent. Therefore, the following can be said. It is preferable to provide a step in which an alkaline solution, the pH value of which is not less than 11, is used for washing. It is more preferable to provide a step in which an alkaline solution, the pH value of which is not less than 12, is used for washing.

TABLE 1

| | pH value | |
|---|---|---|
| | (maximum value in step) | Ratio of reduction (%) |
| Comparative | 7 | 90 |
| Example 1 | (Purified water) | |
| Example 3 | 10 | 93 |
| Example 2 | 11 | 99 |
| Example 1 | 12 | >99.9 |

The present invention can be utilized for manufacturing a magnetic recording medium, a magnetic recording and reproducing apparatus and so forth.

1. A method of working a workpiece containing magnetic material comprising:
a working step in which a workpiece containing magnetic material is worked by means of dry etching; and
a washing step in which the workpiece is washed by an alkaline solution.

2. A method of working a workpiece containing magnetic material according to claim 1, wherein the washing step includes a scrubbing step in which a surface of the workpiece is scrubbed by a piece of sponge in the alkaline solution.

3. A method of working a workpiece containing magnetic material according to claim 1, wherein the washing step includes an ultrasonic washing step in which the workpiece is washed by ultrasonic washing in the alkaline solution.

4. A method of working a workpiece containing magnetic material according to claim 3, wherein an ultrasonic frequency of the ultrasonic washing is increased high.

5. A method of working a workpiece containing magnetic material according to claim 1, wherein the dry etching is conducted in a reactive gas.

6. A method of working a workpiece containing magnetic material according to claim 5, wherein the reactive gas includes at least one of halogen group gas and oxygen group gas.

7. A method of working a workpiece containing magnetic material according to claim 1, wherein the alkaline solution contains ammonia.

8. A method of manufacturing a magnetic recording medium containing magnetic material by the method of working a workpiece containing magnetic material described in claim 1.
